(19) United States
(12) Patent Application Publication
(10) Pub. No.: US 2007/0093249 A1
(43) Pub. Date: Apr. 26, 2007

(54) SS7 Link failover communications over existing cellular networks

(75) Inventors: Shadi Khoshaba, Skokie, IL (US); Nikhil Marathe, Chicago, IL (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/255,485

(22) Filed: Oct. 21, 2005

(51) Int. Cl. H04Q 7/20

(52) U.S. Cl. 455/445; 455/428; 455/422.1

(57) ABSTRACT

A method of providing a telecommunication system, including transferring data over a standard link between a first and a second telecommunication device in a telecommunication network and establishing a wireless cellular link to transfer the data between the first and second telecommunication devices when the data transfer over the standard communication link is impaired. The first device may be a Service Switching Point (SSP), and the second device may be a Signal Transfer Point (STP). The standard link may include a hardwire or an optical link. In the wireless cellular link, data is typically transferred using a Signaling System 7 protocol over a cellular network and a Public Switched Telephone Network. The wireless cellular link may be established in response to a failure detected in the standard link. Signals provided by the first device may be converted to and from a format for transmission over the wireless cellular link.

### BACKGROUND OF THE INVENTION

1. Field of the Invention

The present invention relates to the field of communication network maintenance. In particular, the present invention discusses a system and method for providing a backup to a standard link of a Signaling System 7 network using a cellular network.

2. Description of the Related Art

In any telephone system, some form of signaling mechanism is used to manage calls, i.e. setup calls, tear down calls, etc. Some general functions of a signaling system include supervising a line or circuit (monitoring the status of a line or circuit to see if it is busy, idle, or requesting service), alerting a user to indicate arrival of an incoming call, and addressing a call (transmitting routing and destination signals over the network, using dial pulses, for example, to deliver a telephonic signal to its destination). Signaling System 7 is often utilized for such purposes. A Signaling System 7 (SS7) is a signaling system that employs a 64 kilobit data circuit to carry packetized machine language messages about a call between machines of a network.

An SS7 operates over a network, separate from a voice network and from the Public Switched Telephone Network (PSTN), to route telephone calls and provide call management. The SS7 network also carries other telephone company services, such as Advanced Intelligent Network (AIN) and Local Number Portability (LNP) services. Some exemplary uses of the SS7 network and protocol include providing for call management and providing enhanced call features, such as call forwarding, call waiting, call screening, call transfer, etc., to a full international network.

An SS7 network generally includes a Service Switching Point (SSP), a Signal Transfer Point (STP), and a Service Control Point (SCP). An SCP is a local database used for determining how a call is handled. The SCP has the ability, for example, to screen ten digits of an 800 number and route calls to the appropriate customer-designated long distance carrier. An SSP is the local exchange of a telephone network. An SSP may be a combination of a voice switch for transferring voice signals and an SS7 switch for transferring call management signals, or may be an adjunct computer connected to the voice switch of the local exchange. The SSP communicates with the voice switch and creates packets for transmission over the SS7 network. The SSP routes and connects the signals under the direction of an SCP. An SSP generally resides at an end office. An end office is a central office to which a telephone subscriber is connected and delivers a dial tone to the subscriber. An STP serves as a router in the SS7 network for transferring signaling messages from one link to another. In normal operation, the first local STP identifies a unique code of the call that identifies an SS7 node in order that an SS7 network may route calls properly. This unique code is known as a point code. A destination point code is identified by, for example, looking up a caller identification (caller ID) or Internet Protocol (IP) address of the receiving caller. Often, an SSP creates a query to find out how a call should be handled. The query is passed through STPs to an SCP that interprets the query based on the criteria in its database and information provided by the SSP. Once the SCP has determined how the call is to be handled, it returns a message through STPs to the SSP. This message instructs the SSP how the call should be handled in the network.

FIG. 1 (Prior Art) illustrates a SS7 network for providing a call management functions. An SSP 102 converts between signals from a voice switch, such as phone 104, and signals transmittable over the SS7 network. STPs 108 and STPs 109 are provided to route SS7 signals throughout the SS7 network. The STPs are typically deployed in mated STP pairs. For example, STPs 108 form a mated STP pair, and STPs 109 form a mated STP pair. An SCP 110 provides a database that may be queried to determine how a call should be handled. The SS7 network elements (i.e., SSPs, STPs, SCPs) are interconnected over standard links, such as fiber optic links, copper cable links, or any other physical links commonly used in the industry.

Typically, SSPs within the SS7 network connect to STPs via multiple (i.e. 2 to 4) standard links that are diversely routed to ensure that local impacts do not cause all communications paths to fail at the same time. Access links (“A” links) 115 connect an SSP 102 to nearby STPs 108. Messages originating from or destined to the signaling end point are commonly transmitted over the “A” link. Extended links (“E” links) 117 connect an SSP to alternate STPs 109, generally STP that are physically remote from the SSP. “E” links provide an alternate signaling path if a “local” STP (i.e., STP 108) cannot be reached via an “A” link. “E” links provide increased resilience and load sharing to the SS7 network. “E” links are not usually provided unless the benefit of a marginally higher degree of reliability justifies the added expense.

Despite the diverse routing of the multiple links discussed above, there may be locations where these links are transported over the same transport facilities. If that single transport facility fails, the standard link becomes inoperative or experiences an outage. The industry as a whole reports anywhere from 50-70 outages within the SS7 network each year. Any outage that lasts a significant amount of time (i.e., 5 seconds or more) may result in costly fines. Thus, the telecommunications industry recognizes the importance of maintaining the integrity of Signaling System 7 (SS7) networks by providing a backup link to the standard links of the SS7 network.

### SUMMARY OF THE INVENTION

The present invention describes a method of providing a telecommunication system, including transferring data over a standard communication link between a first and a second telecommunication device in a telecommunication network, and establishing a wireless cellular link to transfer the data between the first and second telecommunication devices when the data transfer over the standard communication link is impaired. Establishing a wireless cellular link includes transmitting data from the first device to the second device via a cellular network. Also, establishing the wireless cellular link further includes transferring data to a Public Switched Telephone Network. Transferring data utilizes a Signaling System 7 protocol. In one aspect of the invention the first device is a Service Switching Point (SSP), and the second device is a Signal Transfer Point (STP). Transferring data over the standard link further includes transferring data over one of (i) a hardwire, and, (ii) an optical link. Establishing the wireless cellular link further includes detecting a failure in the standard link, and automatically establishing the wireless cellular link in response to detecting the failure. Establishing the wireless cellular link further includes converting signals provided by the first device in a first format to signals in a second format for transmission over the wireless cellular link.

In another aspect, the invention describes a system and method for providing a backup connection to a Signaling System 7 (SS7) communication network. The SS7 communication network includes at least one Service Switching Point (SSP) for converting between signals from a voice switch and an SS7 signal and at least one Signal Transfer Point (STP) for routing SS7 signals through the SS7 communication network. The at least one STP is connected to the at least one SSP via at least one standard link. The at least one SSP generally refers to a plurality of SSPs, and the at least one STP generally refers to a plurality of STPs. Also, the at least one standard link generally refers to a plurality of standard links. The standard link may be fiber optic links, copper cable links, or any other standard links used in the industry. A wireless communication link may be activated to transfer information between the at least one SSP and the at least one STP when a failure is detected in the at least one standard link. The wireless communication link typically includes a cellular network, a Public Switched Telephone Network (PSTN), and a mediation device for converting between a signal transmittable over the at least one standard link and a signal transmittable over the cellular network. The wireless communication link may be activated when a failure is detected in the at least one standard link.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 (Prior Art) illustrates an exemplary Signal Switching 7 (SS7) communication network for providing call management functions;

FIG. 2 illustrates an exemplary embodiment of the present invention for providing a wireless backup to a standard link of the SS7 network;

FIGS. 3 and 4 illustrate a flowchart of a process for activating one or more wireless backup links to the SS7 network.

### DETAILED DESCRIPTION OF THE INVENTION

In view of the above, the present invention through one or more of its arious aspects and/or embodiments is presented to provide one or more advantages, such as those noted below.

The invention describes a method of providing a telecommunication system, including transferring data over a standard communication link between a first and a second telecommunication device in a telecommunication network, and establishing a wireless cellular link to transfer the data between the first and second telecommunication devices when the data transfer over the standard communication link is impaired. Establishing a wireless cellular link includes transmitting data from the first device to the second device via a cellular network. Also, establishing the wireless cellular link further includes transferring data to a Public Switched Telephone Network. Transferring data utilizes a Signaling System 7 protocol. In one aspect of the invention the first device is a Service Switching Point (SSP), and the second device is a Signal Transfer Point (STP). Transferring data over the standard communication link further includes transferring data over one of (i) a hardwire, and, (ii) an optical link. Establishing the wireless cellular link further includes detecting a failure in the standard communication link, and automatically establishing the wireless cellular link in response to detecting the failure. Establishing the wireless cellular link further includes converting. signals provided by the first device in a first format to signals in a second format for transmission over the wireless cellular link.

The invention also describes a system for providing a backup connection to a Signaling System 7 (SS7) communication network. The SS7 communication network includes at least one Service Switching Point (SSP) for converting between signals from a voice switch and an SS7 signal and at least one Signal Transfer Point (STP) for routing SS7 signals through the SS7 communication network. The at least one STP is connected to the at least one SSP via at least one standard communication link. The at least one SSP generally refers to a plurality of SSPs, and the at least one STP generally refers to a plurality of STPs. Also, the at least one standard communication link generally refers to a plurality of standard communication links. The standard communication link may be fiber optic links, copper cable links, or any other standard links used in the industry. A wireless communication link may be activated to transfer information between the at least one SSP and the at least one STP when a failure is detected in the at least one standard communication link. The wireless communication link typically includes a cellular network, a Public Switched Telephone Network (PSTN), and a mediation device for converting between a signal transmittable over the at least one standard communication link and a signal transmittable over the cellular network.

The invention further describes a method of providing a backup signaling system for a Signaling System 7 (SS7) communication network. The method includes detecting a failure of at least one standard SS7 link between at least one Service Switching Point (SSP) and at least one Signal Transfer Point (STP). The method establishes an alternative communication link between the at least one SSP and at least one STP that provides a backup to the standard SS7 link. In the method, the at least one SSP further includes a plurality of SSPs, and the at least one STP further includes a plurality of STPs. Also, the at least one standard link may refer to a plurality of standard links. The method of the invention further includes converting between a signal transmittable over the at least one standard link and a signal transmittable over the alternative communication link, and transmitting the converted signal over a cellular network and a PSTN. In an exemplary embodiment, the alternative communication link may be provided over a cellular network.

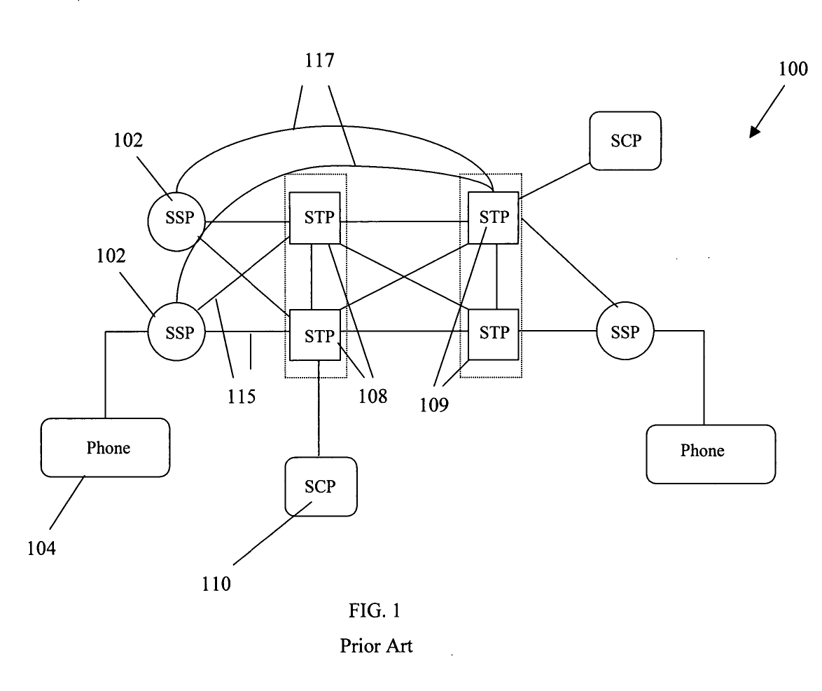

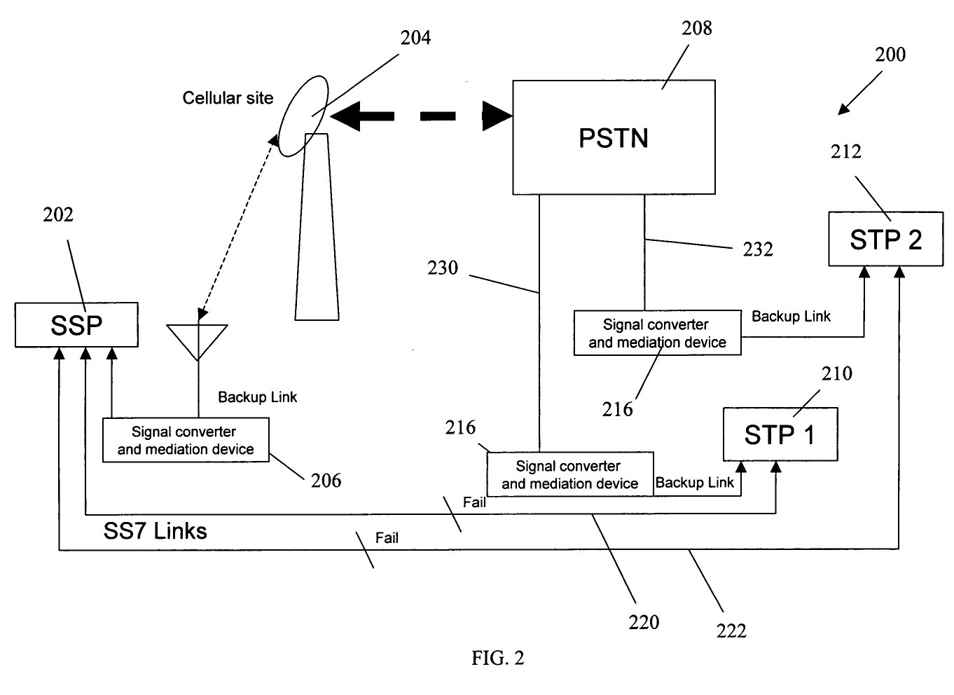

FIG. 2 illustrates an exemplary embodiment 200 of the present invention for providing a wireless cellular backup to a standard link of an SS7 network. The network includes multiple standard links and a wireless cellular backup link to establish communication between SS7 devices. The standard SS7 network connects at least one SSP to at least one STP over these multiple standard links. In the example of FIG. 1, SSP Switch 202 connects to a first STP (STP1) 210 over a first standard link 220 and connects to a second STP (STP2) 212 over a second standard link 222. These standard links may be made of copper cable, fiber optic cable, or other suitable cable used in the industry. The wireless cellular backup link may include one or more mediation devices (206 and 216), a cellular network 204, and the Public Switched Telephone Network (PSTN) 208. A mediation device may be a stand alone device or a device integrated into an associated SS7 device, such as an associated SSP. Mediation devices 206 and 216 are capable of converting between a protocol for transmitting a signal over the standard link and a protocol for transmitting a signal over a cellular network. For example, the mediation device 206 may convert the SS7 protocol into an SS7oIP based transport protocol for wireless delivery to an SS7 node, such as an STP. Depending on the type of SS7 device, the signal may or may not need to be converted back to straight SS7 protocol using mediation devices 216.

The mediation device may serve to convert SS7 signals into a format and speed acceptable to the wireless link, while being transparent to the SSP/STP. Transparency refers to the ability of the mediation device to change communication links without the SS7 devices being aware of the change. Typical next generation wireless cellular networks using Code Division Multiple Access (CDMA) and General Packet Radio Services (GPRS) provide a link capacity of a few hundred kilobits per second. Certain current SS7 links in North America are typically provided on 56-64 kpbs circuitry and may be transmitted to the wireless network transparent to SSP and STPs. Actual SS7 data rates are not as high, and a lower link capacity may be acceptable. The mediation device may have the ability to make that choice. Current SS7 links are configured to the STP they terminate in. The invention therefore configures SSPs and STPs (either prior to failover or at the time of failover) so as to recognize SS7 failover calls from different SS7 elements (i.e., SSPs and STPs). The mediation device 206 communicates with cellular site 204 over a wireless cellular network connection, both transmitting and receiving signals. The cellular site communicates with the Public Switched Telephone Network (PSTN) 208, which connects via standard link 230 to STP1 210 and standard link 232 to STP2 212. When standard links 220 and 222 fail, an appropriate wireless cellular backup link may be activated. Multiple connections may be established between SSPs and STPs over the wireless cellular backup link. The standard link(s) may be monitored in order to determine when the standard link returns to an operative state, so that the signal may be switched back from the backup link to the standard link.

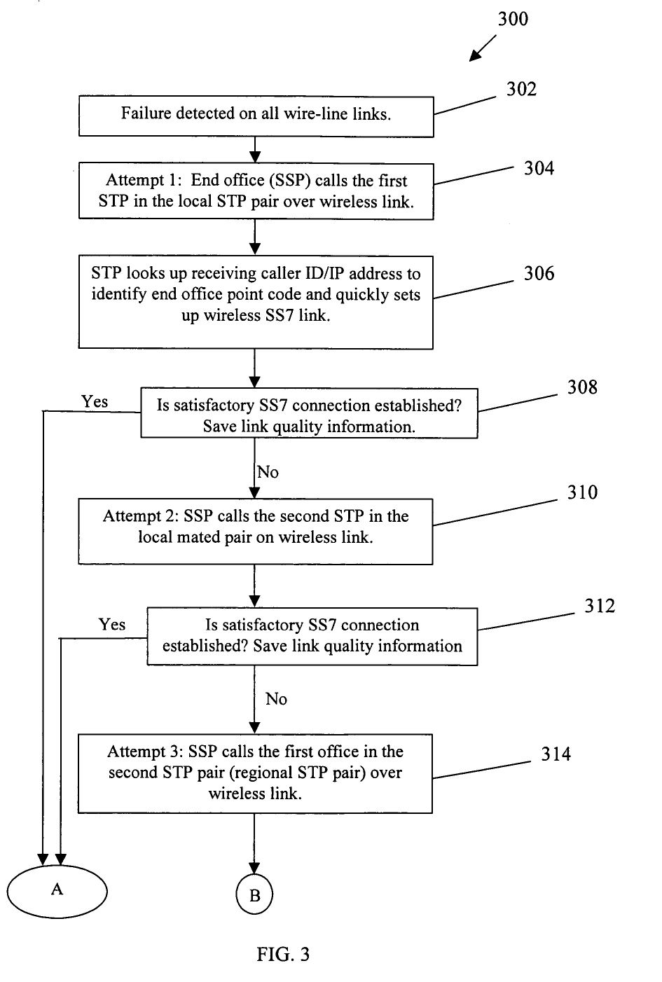

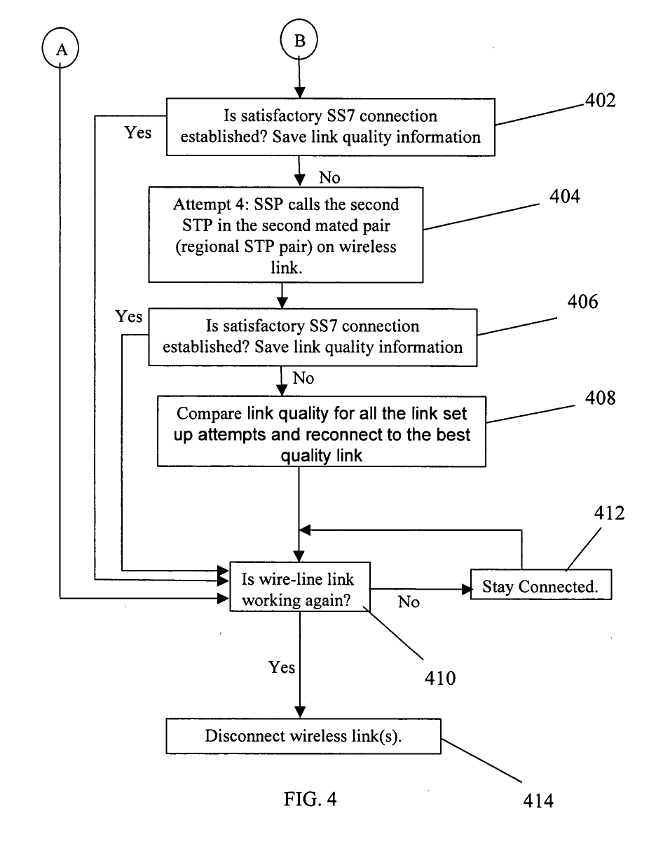

FIGS. 3 and 4 illustrate a flowchart 300 of a process for activating one or more wireless cellular backup links to the SS7 network. The process of providing one or more backup links begins when a failure is detected in one or more the standard links (Box 302). In Box 304, an SSP in an end office calls a first local STP over a wireless cellular link. In FIG. 2, this first local STP may be represented by STP1 210. A wireless cellular backup link is then activated between the SSP and the first local STP (Box 306). The wireless cellular link activated in Box 306 is analogous to an “A” link in the SS7 network. In Box 308, the link activated in Box 306 is tested for quality of service issues to determine whether the link is satisfactory for transmission purposes. Some exemplary quality of service issues include low data rate, too many bit resends, noise levels, delay times, out-of-sync packet arrival, etc. These quality of service issues may occur, for instance, due to bad wireless cellular reception or disruptive weather conditions. Data related to the quality of the link may be saved, usually at the mediation device. If the link to the first local STP is satisfactory, the signal is transferred over the backup link, and the failed standard link is monitored (Box 410). The signal may be transferred back to the standard link once the standard link returns to an operative state.

If the connection activated in Box 306 is found not to be satisfactory (i.e., fails quality of service test), a second attempt to provide a backup link may be made in which the SSP calls a second STP (Box 310). Generally, the second attempt is made to the STP (i.e., STP2 212 of FIG. 2) that is mated to the first STP contacted. In Box 312, a test is made of the link activated in Box 310 to determine whether the connection is satisfactory. In the event that the link to the second local STP is satisfactory, the signal is transferred over the backup link, and the failed standard link is monitored (Box 410). Data related to the quality of the link may be saved, usually at the mediation device. The signal may be transferred back to the standard link once the standard link returns to an operative state.

Some regions may have multiple STP pairs. If the connection activated in Box 310 is found not to be satisfactory, a third attempt to provide a backup link may be made (Box 314). The third attempt is generally made to a first STP in a second (regional) STP pair over a wireless cellular link. The wireless cellular link activated in Box 314 is analogous to an “E” link in the SS7 network (shown in FIG. 1). In Box 402, a test is made of the link activated in Box 314 to determine whether the connection is satisfactory. In the event that the connection of Box 314 is satisfactory, the signal is transferred over the backup link, and the failed standard link is monitored (Box 410). Data related to the quality of the link may be saved, usually at the mediation device. The signal may be transferred back to the standard link once the standard link returns to an operative state.

If the connection activated in Box 314 is not satisfactory, a fourth attempt to provide a backup link may be made to the second STP in the second (regional) STP pair over the wireless cellular link (Box 404). In Box 406, a test is made of the link activated in Box 404 to determine whether the connection is satisfactory. In the event that the connection of Box 404 is satisfactory, the signal is transferred over the backup link, and the failed standard link is monitored (Box 410). Data related to the quality of the link may be saved, usually at the mediation device. The signal may be transferred back to the standard link once it returns to an operative state. In Box 408, the mediation device may compare the link quality for all of the link set-up attempts and choose to reconnect to one of the links based on a criteria determined at the mediation device.

Although the exemplary flowchart of FIGS. 3 and 4 shows four attempts at activating a wireless cellular backup link, any number of attempts to activate a backup link may be made to any number of switches until a satisfactory connection is activated. Although there are multiple possible routes between any two nodes in a cellular network, the backup links locate the closest STP over a shortest path through the cellular network. This reduces the number of cellular network elements crossed, thereby reducing the probability failure of the backup link. Once the backup link is activated, routing information is updated to reflect the new configuration, links, and route.

The standard link is monitored continuously in Box 410. As long as the standard link remains inoperative, the SS7 link stays connected over the wireless cellular connection (Box 412). If the standard link is found to be operative, the wireless cellular link is disconnected (Box 414), and signal transfer is resumed over the standard link.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices may likewise be constructed to implement the methods described herein. Furthermore, alternative software implementations including, but not limited to, distributed processing or component/object distributed processing, parallel processing, or virtual machine processing may also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method of providing a telecommunication, comprising:
transferring data over a standard communication link between a first and a second telecommunication device in a telecommunication network; and
establishing a wireless cellular link to transfer the data between the first and second telecommunication devices when the data transfer over the standard communication link is impaired.

2. The method of claim 1, wherein establishing the wireless cellular link further comprises transmitting data from the first device to the second device via a cellular network.

3. The method of claim 2, wherein establishing the wireless cellular link further comprises transferring data to a Public Switched Telephone Network from the cellular network.

4. The method of claim 1, wherein transferring data further comprises utilizes a Signaling System 7 protocol.

5. The method of claim 1, wherein the first device is a Service Switching Point (SSP) and the second device is a Signal Transfer Point (STP).

6. The method of claim 1, wherein transferring data over the standard communication link further comprises transferring data over one of (i) a hardwire, and (ii) an optical link.

7. The method of claim 1, wherein establishing the wireless cellular link further comprises:
detecting a failure in the standard communication link; and
automatically establishing the wireless cellular link in response to detecting the failure in the standard communication link.

8. The method of claim 1, wherein establishing the wireless cellular link further comprises converting signals provided by the first telecommunication device in a first format to signals in a second format for transmission over the wireless cellular link.

9. A telecommunication system, comprising:
a standard communication link for transferring data between a first and a second telecommunication device in a telecommunication network; and
a wireless cellular link established for transferring the data between the first and second telecommunication devices when the data transfer over the standard communication link is impaired.

10. The method of claim 9, wherein the wireless cellular link further comprises a cellular network.

11. The method of claim 10, wherein the wireless cellular link further comprises a Public Switched Telephone Network.

12. The method of claim 9, wherein transferring data further comprises utilizing a Signaling System 7 protocol.

13. The method of claim 9, wherein the first device is a Service Switching Point (SSP) and the second device is a Signal Transfer Point (STP).

14. The method of claim 9, wherein the standard link further comprises one of (i) a hardwire, and (ii) an optical link.

15. The method of claim 9, wherein establishing the wireless cellular link further comprises:
detecting a failure in the standard communication link; and
automatically establishing the wireless cellular link in response to detecting the failure in the standard communication link.

16. The method of claim 9, wherein establishing the wireless cellular link further comprises converting signals provided by the first telecommunication device in a first format to signals in a second format for transmission over the wireless cellular link.

17. A system for providing a backup connection to a Signaling System 7 (SS7) communication network, comprising:
at least one Service Switching Point (SSP) for converting between signals from a voice switch and an SS7 signal;
at least one Signal Transfer Point (STP) for routing SS7 signals through the SS7 communication network that is connected to the at least one SSP via at least one standard link; and
a wireless cellular communication link that is activated to transfer information between the at least one SSP and the at least one STP when a failure is detected in the at least one standard communication link.

18. The system of claim 17, wherein the at least one SSP further comprises a plurality of SSPs.

19. The system of claim 17, wherein the at least one STP further comprises a plurality of STPs.

20. The system of claim 17, wherein the at least one standard communication link further comprises a plurality of standard communication links.

21. The system of claim 17, wherein the wireless cellular communication link further comprises:
a cellular network;
a Public Switched Telephone Network (PSTN); and
a mediation device for converting between a signal transmittable over the at least one standard communication link and a signal transmittable over the cellular network.

22. The method of claim 21, where the mediation device further converts SS7 data bits into a format and speed acceptable to the cellular network while being transparent to the at least one SSP and the at least one STP.

23. A method of providing a backup signaling system for a Signaling System 7 (SS7) communication network, comprising:
detecting a failure of at least one standard SS7 link between at least one Service Switching Point (SSP) that converts between signals from a voice switch and an SS7 signal and at least one Signal Transfer Point (STP) that routes the SS7 signal through the SS7 network; and
establishing a wireless cellular communication link between the at least one SSP and at least one STP that provides a backup signaling system to the SS7 network.

24. The method of claim 23, wherein the at least one SSP further comprises a plurality of SSPs.

25. The method of claim 23, wherein the at least one STP further comprises a plurality of STPs.

26. The method of claim 23, wherein the at least one standard link further comprises a plurality of standard links.

27. The method of claim 23, further comprising converting between a signal transmittable over the at least one standard link and a signal transmittable over the wireless cellular communication link, and transmitting the converted signal over a cellular network and a PSTN.

28. The method of claim 23, wherein the wireless cellular communication link is provided over a cellular network.
